(19) United States
(12) Patent Application Publication
(10) Pub. No.: US 2014/0120926 A1
(43) Pub. Date: May 1, 2014

(54) METHOD OF OPERATING BASE STATION AND TERMINAL IN CELLULAR TELECOMMUNICATION SYSTEM FOR OPERATING MULTIPLE BEAMS

(71) Applicant: Electronics and Telecommunications Research Institute, Daejeon (KR)

(72) Inventors: Jae Sheung SHIN, Daejeon (KR); Sook Yang KANG, Daejeon (KR); Eun Ah KIM, Daejeon (KR); Hyun Seo PARK, Daejeon (KR); Sung Min OH, Daejeon (KR); Ae Soon PARK, Daejeon (KR)

(73) Assignee: Electronics and Telecommunications Research Institute, Daejeon (KR)

(21) Appl. No.: 13/780,264

(22) Filed: Feb. 28, 2013

(30) Foreign Application Priority Data
Oct. 29, 2012 (KR) 10-2012-0120665

(51) Int. Cl. H04W 72/04

(52) U.S. Cl. CPC H04W 72/04
USPC 455/450

(57) ABSTRACT

Provided is an operation method of a cellular telecommunication system for operating multiple beams. In an operation method of a base station, a beam identifier (ID) is allocated to each of the multiple beams, and a terminal reports a beam ID of a selected beam to the base station. When the operation method of the cellular telecommunication system is used, the base station can rapidly sense the entry of the terminal into a specific beam area. Even when the terminal moves between beam areas, it is possible to rapidly make a beam area change with a minimum overhead without performing random access again or performing a complex procedure such as a handover procedure.

### CLAIM FOR PRIORITY

This application claims priority to Korean Patent Application No. 10-2012-0120665 filed on Oct. 29, 2012 in the Korean Intellectual Property Office (KIPO), the entire contents of which are hereby incorporated by reference.

### BACKGROUND

1. Technical Field

Example embodiments of the present invention relate in general to a method of operating a base station and a terminal in a cellular telecommunication system for operating multiple beams based on beam forming technology, and more specifically, to a method of operating a base station and a terminal in a cellular telecommunication system operable in high frequency bands such as a super high frequency (SHF) and an extremely high frequency (EHF).

2. Related Art

Various technologies for increasing the capacity of a telecommunication network are being studied based on prediction that the amount of mobile data will increase by a factor of about 1000 in the next 10 years.

Among various technologies, radio transmission technology using a frequency of the SHF/EFH band capable of securing an idle bandwidth of 1 GHz or more and increasing frequency efficiency, is forecast to be used.

Unlike transmission using existing cellular bands, transmission using the SHF/EHF band has a constraint that line of sight (LOS) shall be ensured in the transmission, but enables fine and precise beam forming to be performed.

Thus, in cellular telecommunication systems using the SHF/EHF band, a scheme of operating multiple beams based on beam forming technology can be adopted. Communication between a base station and a terminal in the above-described cellular telecommunication system is possible when the terminal is located in an LOS area in which a beam transmitted by the base station is receivable.

### SUMMARY

Accordingly, example embodiments of the present invention are provided to substantially obviate one or more problems due to limitations and disadvantages of the related art.

Example embodiments of the present invention provide a method of operating a base station and a terminal so that the base station can form multiple beams and recognize a beam area in which the terminal is located.

Example embodiments of the present invention provide a method of operating a base station and a terminal so that the terminal can rapidly process switching among a plurality of beam areas formed by the base station in a cellular telecommunication system for operating multiple beams.

In some example embodiments, a method of operating a base station in a cellular telecommunication system for operating multiple beams, includes: forming (the) multiple beams; allocating a beam identifier (ID) to each of the multiple beams, and transmitting the beam ID corresponding to each beam using each beam; and receiving the beam ID of the beam selected by a terminal from the terminal.

In the method, the cellular telecommunication system may use an SHF or EHF band as an operation band.

In the method, the beam ID may be broadcast through a synchronization signal or system information broadcast channel transmitted using each beam.

In the method, the beam ID may be received from the terminal through a random access channel.

In other example embodiments, a method of operating a terminal in a cellular telecommunication system for operating multiple beams, includes: receiving at least one beam; selecting one of the received at least one beam, and acquiring a beam ID from the selected beam; and reporting the acquired beam ID to a base station.

In the method, the cellular telecommunication system may use an SHF or EHF band as an operation band.

In the method, the beam ID may be acquired from a synchronization signal or system information broadcast channel received through the selected beam.

In the method, the acquired beam ID may be reported to the base station through a random access channel.

In still other example embodiments, a method of operating a base station in a cellular telecommunication system for operating multiple beams, includes: receiving an ID and radio quality measurement results of at least one beam received by a terminal from the terminal; determining a beam area change for the terminal based on the radio quality measurement results; instructing the terminal for which the beam area change is determined to make the beam area change using a first message, and instructing the terminal to activate communication in a new beam area using a second message; and receiving a response including results of the beam area change and results of the communication activation in the new beam area from the terminal through a third message.

In the method, the determining may include: determining the beam area change to a second beam when the second beam has better radio quality than a first beam in service for the terminal based on the radio quality measurement results reported from the terminal.

In the method, the first message and the third message may include radio resource control (RRC) layer messages. At this time, the first message may include an RRC connection reconfiguration message, and the third message may include an RRC connection reconfiguration complete message.

In the method, the second message may include a media access control (MAC) layer control element (CE) message.

In still other example embodiments, a method of operating a terminal in a cellular telecommunication system for operating multiple beams, includes: reporting an ID and radio quality measurement results of at least one beam received by the terminal to a base station; receiving a beam area change instruction from the base station through a first message, and receiving an instruction for activating communication in a new beam area through a second message; and transmitting a response including beam area change results and communication activation results in the new beam area to the base station using a third message.

In the method, the first message and the third message may include RRC layer messages. At this time, the first message may include an RRC connection reconfiguration message, and the third message may include an RRC connection reconfiguration complete message.

In the method, the second message may include a MAC layer CE message.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a beam forming concept in a cellular telecommunication system serving as an environment to which a method in accordance with an example embodiment of the present invention is applied;

FIG. 2 is a conceptual diagram illustrating the step in which a base station performs beam forming and ID information transmission in an operation method of a cellular telecommunication system in accordance with an example embodiment of the present invention;

FIG. 3 is a conceptual diagram illustrating the step in which a terminal reports an entry into a beam area in the operation method of the cellular telecommunication system in accordance with an example embodiment of the present invention;

FIG. 4 is a message sequence diagram illustrating beam ID broadcasting by the base station and reporting of the entry into the beam area by the terminal in the operation method of the cellular telecommunication system in accordance with an example embodiment of the present invention;

FIG. 5 is a conceptual diagram illustrating the step in which a beam area change for the terminal is processed in the operation method of the cellular telecommunication system in accordance with an example embodiment of the present invention;

FIG. 6 is a message sequence diagram illustrating the step in which a beam area change for the terminal is processed in the operation method of the cellular telecommunication system in accordance with an example embodiment of the present invention;

FIG. 7 is a flowchart illustrating an operation method of the base station in accordance with an example embodiment of the present invention;

FIG. 8 is a flowchart illustrating an operation method of the base station in accordance with another example embodiment of the present invention;

FIG. 9 is a flowchart illustrating an operation method of the terminal in accordance with an example embodiment of the present invention; and

FIG. 10 is a flowchart illustrating an operation method of the terminal in accordance with another example embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

However, there is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used herein may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), mobile node, mobile, or other terms. Various embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited thereto.

The term “base station” used herein generally denotes a fixed or mobile point that communicates with a terminal, and may be referred to as a Node-B, evolved Node-B (eNB), base transceiver system (BTS), access point, relay, femto-cell, and other terms.

Hereinafter, preferred embodiments of the present invention will be described in more detail with reference to the accompanying drawings. To facilitate overall understanding of the invention, the same reference numerals in the drawings denote the same elements, and repetitive description of the same elements is omitted.

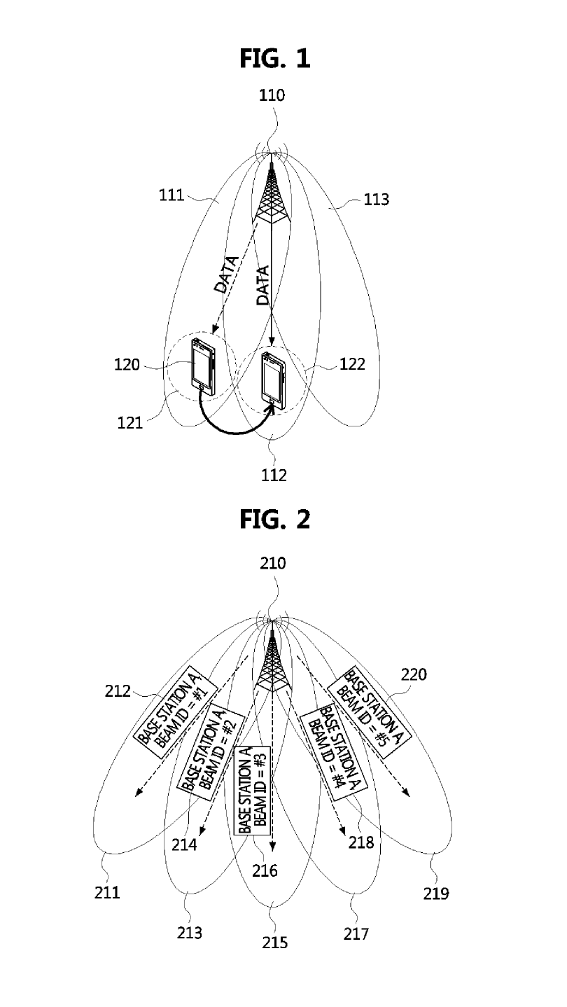

FIG. 1 is a conceptual diagram illustrating a beam forming concept in a cellular telecommunication system serving as an environment to which a method in accordance with an example embodiment of the present invention is applied.

Referring to FIG. 1, a base station 110 including a plurality of antennas, can operate fine and precise beams (for example, three beams 111, 112, and 113 in FIG. 1) using beam forming technology, and transmit independent data to terminals located in beam areas using the beams.

During radio transmission through the multiple beams, the base station can transmit data to terminals of a corresponding beam area using independent resources and radio channels for every beam. That is, each beam can have radio channels for transmitting control information and data such as an independent control channel (for example, a physical dedicated control channel (PDCCH)), and a data channel (for example, a physical data shared channel (PDSCH)), and independent resources for each terminal can be allocated by a scheduler of the base station and used.

At this time, it is necessary for a base station, which operates multiple beams, to determine a transmission beam to be used for data transmission to a corresponding terminal. For this, the base station requires a procedure for recognizing a transmission beam area in which the terminal is located. The base station transmits data to the terminal through the recognized transmission beam.

For example, when a terminal 120 illustrated in FIG. 1 enters from an area of the first beam 111 to an area of the second beam 112 by moving from a first location 121 to a second location 122, a procedure in which the base station can recognize the above-described entry, and a procedure in which the base station can transmit data through a new transmission beam and the terminal can also receive data through the new transmission beam, are necessary.

Hereinafter, an operation method of the cellular telecommunication system in accordance with an example embodiment of the present invention will be described as 1) a method in which the base station performs beam forming and beam ID transmission, 2) a method in which the terminal selects its own optimum beam and reports the selected optimum beam, and 3) a processing method when the terminal moves to another beam area. Hereinafter, methods 1) to 3) as will be described later, can be independently implemented. A combination of at least two methods among the three methods can be implemented.

On the other hand, in the following example embodiments, the present invention is directly applied to a cellular telecommunication system operable in an SHF (a band of 3 to 30 GHz in a general definition)/EHF (a band of 30 to 300 GHz in a general definition) band. (An) Operation frequency band of the present invention is not necessarily limited to the SHF/EHF band. The present invention can be applied to any cellular telecommunication systems operable in a frequency band in which multiple beams are operable through beam forming.

(First Step) Beam Forming and Beam ID Information Transmission by Base Station

FIG. 2 is a conceptual diagram illustrating the step in which a base station performs beam forming and ID information transmission in the operation method of the cellular telecommunication system in accordance with an example embodiment of the present invention.

Referring to FIG. 2, the base station allocates a unique ID for each beam, and broadcasts the allocated ID using a separate resource in an initial operation.

As described above, the base station can generate and operate fine and precise beams 211, 213, 215, 217, and 219 using beam forming technologies (in particular, in the SHF/EHF band). Each beam can have radio channels for transmitting control information and data such as an independent PDCCH and PDSCH and the like, and independent resources for each terminal can be allocated by a scheduler of the base station and used.

Accordingly, the base station can allocate an ID to each generated beam. Beam ID information 212, 214, 216, 218, and 220 can be transmitted using synchronization signals corresponding to beams, or using system information transmission channels corresponding to the beams.

In a 3rd Generation Partnership Project (3GPP) Long Term Evolution (LTE) system, for example, the synchronization signal may be a primary synchronization signal (PSS) and a secondary synchronization signal (SSS), and the system information broadcast channel may be a physical broadcast channel (PBCH). Beam ID information similar to cell ID (for example, peripheral cell ID (PCI)) information included in the PSS and SSS signals may be additionally included, or a cell ID may be redesigned in a form in which the beam ID information is added to the cell ID. In the PBCH, beam ID information can be transmitted through system information regarding a master information block (MIB), a system information block (SIB), or the like.

(Second Step) Report of Entry into Beam Area by Terminal

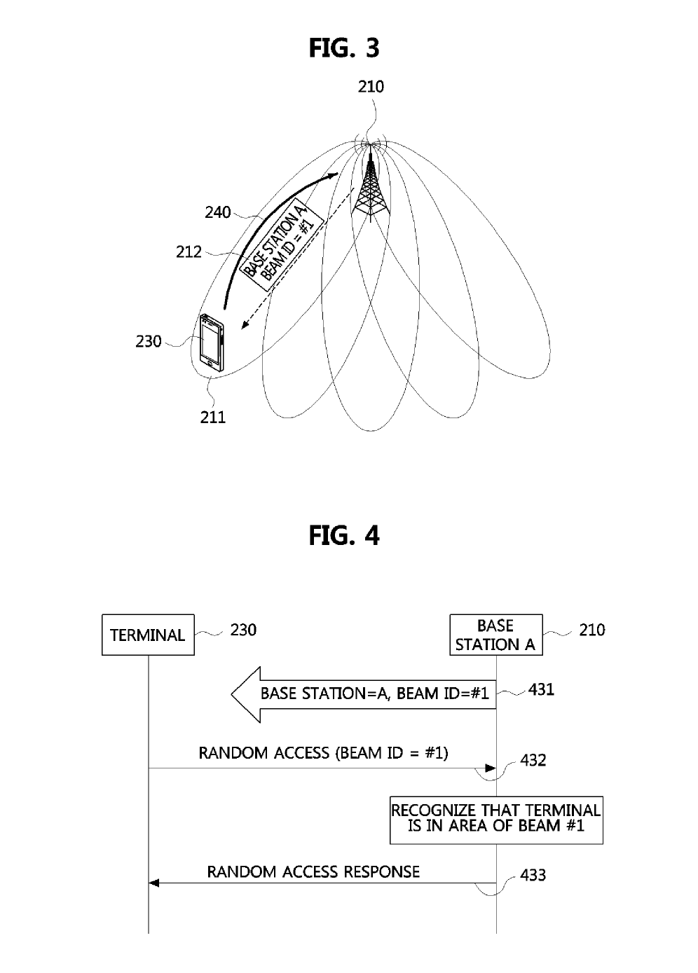

FIG. 3 is a conceptual diagram illustrating the step in which a terminal reports an entry into a beam area in the operation method of the cellular telecommunication system in accordance with an example embodiment of the present invention.

Referring to FIG. 3, when entering an area of a base station 210, a terminal 230 can select an optimum beam 211 from among beams transmitted by the base station 210 receivable by the terminal 230, and transmit information 212 designating the selected beam to the base station 210.

Although the terminal can generally select a beam having best reception quality, a criterion for selecting its own optimum beam may differ according to an operation policy (for example, a load, a distribution, or the like) of the cellular telecommunication system.

At this time, information designating a beam selected by the terminal can include a beam ID transmitted by the base station in the above-described first step.

On the other hand, as an example of a method of transmitting the information designating the selected beam to the base station, the information can be configured to be transmitted as a random access message (for example, including a random access preamble) through a random access channel. Because the terminal is likely to be in a state in which uplink synchronization with the base station is not acquired, it is preferable to use a random access scheme, but other message transmission methods may be used.

Referring to FIG. 3, the base station receiving the random access message can recognize that an optimum beam transmitted by the base station currently receivable by the terminal is a beam of Beam ID=#1 through beam ID information specifying the optimum beam included in the message.

FIG. 4 is a message sequence diagram illustrating beam ID broadcasting by the base station and reporting of the entry into the beam area by the terminal in the operation method of the cellular telecommunication system in accordance with an example embodiment of the present invention.

Referring to FIG. 4, the terminal 230 receives multiple beams transmitted by the base station 210, selects an optimum beam from among the beams, and acquires an ID of the selected optimum beam (431). That is, process 431 in which the terminal acquires a beam ID transmitted from the base station in FIG. 4 corresponds to a first-half part of a first step operation and a second step operation described with reference to FIGS. 2 and 3.

As described above, the beam ID transmitted by the base station in process 431 can be broadcast through a synchronization signal or downlink broadcast channel.

Next, the terminal transmits the ID of the optimum beam acquired in process 431 to the base station (432). A method in which the terminal transmits the optimum beam ID to the base station can be performed using the random access channel in the random access scheme.

Next, process 433 of transmitting a random access response as a response for a random access preamble transmitted by the terminal can be configured to be performed.

(Third Step) Step in which Beam Area Change for Terminal is Processed

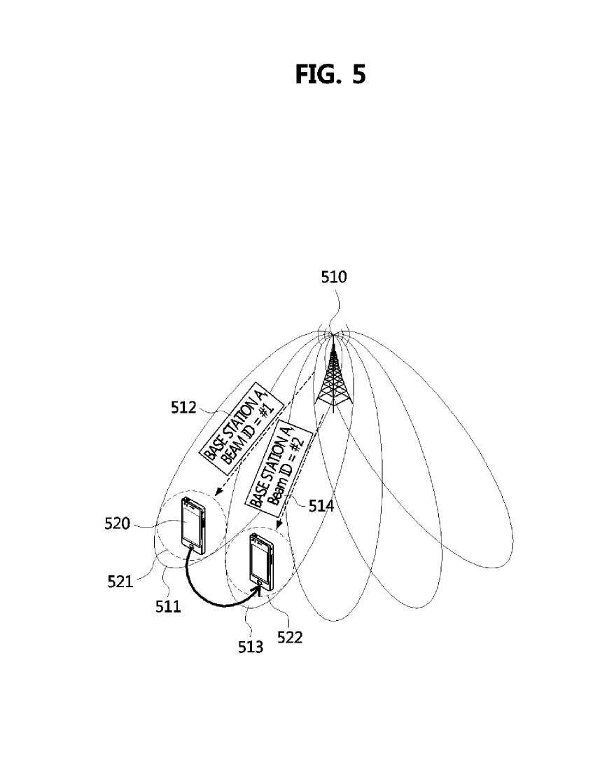

FIG. 5 is a conceptual diagram illustrating the step in which a beam area change for the terminal is processed in the operation method of the cellular telecommunication system in accordance with an example embodiment of the present invention.

Referring to FIG. 5, a terminal 520 moves from an area 521 of a first beam 511 to an area 522 of a second beam 513. At this time, a base station 510 allocates beam IDs 512 and 514 respectively to the first beam 511 and the second beam 513, and transmits the beam IDs 512 and 514 as described above with reference to the first step.

The terminal periodically reports information (a beam ID and a radio quality measurement result) regarding at least one beam received by the terminal as a measurement report to the base station. The base station determines whether a beam area change for the terminal is necessary based on the measurement report from the terminal, and instructs the terminal to make the beam area change when the beam area change is determined to be necessary.

The present invention is characterized in that the beam area change for the terminal is processed using an RRC layer message and a MAC layer message without using a separate random access procedure and a handover procedure.

In the present invention, each of the multiple beams operable by the base station can be understood as a concept corresponding to a carrier operable by the base station in an existing cellular system. Accordingly, in the present invention, the beam area change can be understood as an additional concept of a carrier operable by the terminal. Without using the separate random access procedure or the handover procedure, information regarding a new beam is delivered through an RRC connection reconfiguration message and then activation of an actually added beam area is rapidly reported by delivering a CE message of the MAC layer.

That is, the present invention provides a method of rapidly switching a beam without a separate random access or a handover procedure when the terminal moves between beams within the base station in a cellular telecommunication system using the SHF/EHF band based on a carrier addition and activation procedure using the RRC layer and the MAC layer CE of 3GPP described above.

Hereinafter, the concept described above with reference to FIG. 5 will be described using messages exchanged between the base station and the terminal.

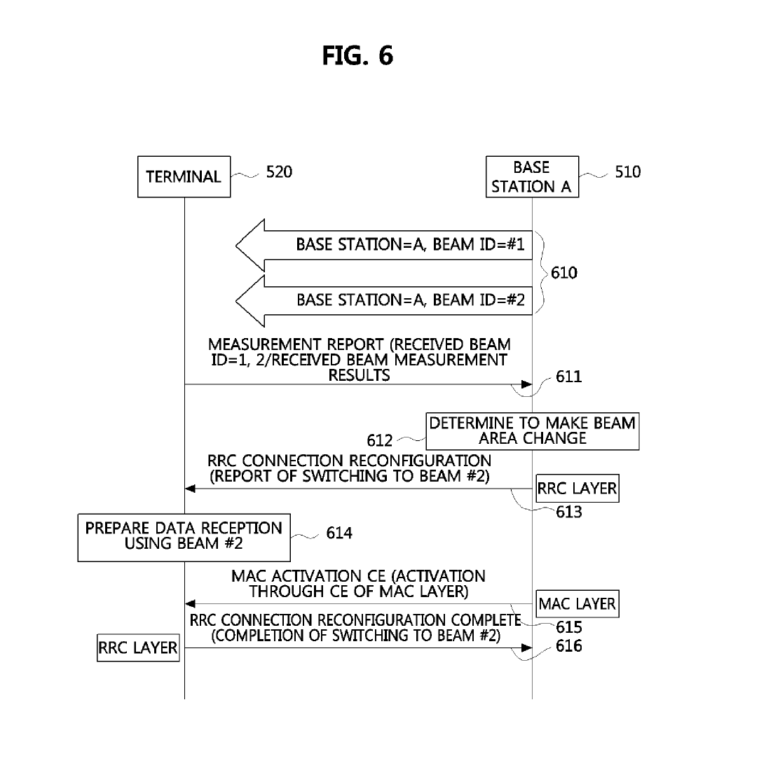

FIG. 6 is a message sequence diagram illustrating the step in which a beam area change for the terminal is processed in the operation method of the cellular telecommunication system in accordance with an example embodiment of the present invention.

Referring to FIG. 6, the terminal 520 periodically or aperiodically measures a radio state after entering an area of the base station 510, and transmits measurement results as a measurement report to the base station (611). On the other hand, before the measurement results are transmitted, the base station is configured to form multiple beams, allocate beam IDs to the multiple beams, and include a beam ID in each beam (610). This is the same as in the first step described above.

The measurement report transmitted by the terminal includes IDs of beams currently received by the terminal and information regarding measured radio qualities and the like.

Based on the beam IDs and the information, the base station recognizes a radio state of the terminal and determines to change to an optimum beam (612). For example, the base station determines a beam area change for the terminal by analyzing measurement results when there are two or more currently receivable beams through a measurement report message delivered from the terminal. For example, when there is a beam having better radio quality than a beam in service among the beams reported by the terminal, the base station can determine the beam area change to the beam having the better radio quality. On the other hand, the term “better” is not limited to only the meaning that the strength of a received signal is necessarily higher, and can be defined by various indices for determining the beam area change so as to improve the entire system performance.

In accordance with an example embodiment of the present invention as described with reference to FIG. 5, when the terminal enters a new beam area within the same base station, a beam can be immediately switched through signal messages of the RRC layer and the MAC layer without a complex procedure.

Accordingly, when switching to the new beam area is determined according to the measurement results, the base station notifies the terminal of the switching to the new beam area through a message of the RRC layer (for example, RRC connection reconfiguration) (613). Accordingly, the terminal prepares reception in the new beam area (614).

Thereafter, the base station activates communication with a new beam using a CE message (for example, a MAC activation/deactivation CE) of the MAC layer (615).

The terminal completing switching to the new beam and communication activation through the RRC layer and the CE of the MAC layer reports results of switching and communication activation to the base station through a response message (for example, RRC connection reconfiguration complete) of the RRC layer (616).

Hereinafter, an operation method from a viewpoint of the base station and an operation method from a viewpoint of the terminal into which the above-described operation method of the cellular telecommunication system in accordance with the example embodiment of the present invention are separated, will be described in further detail.

Operation Method of Base Station in Accordance with Example Embodiment of Present Invention

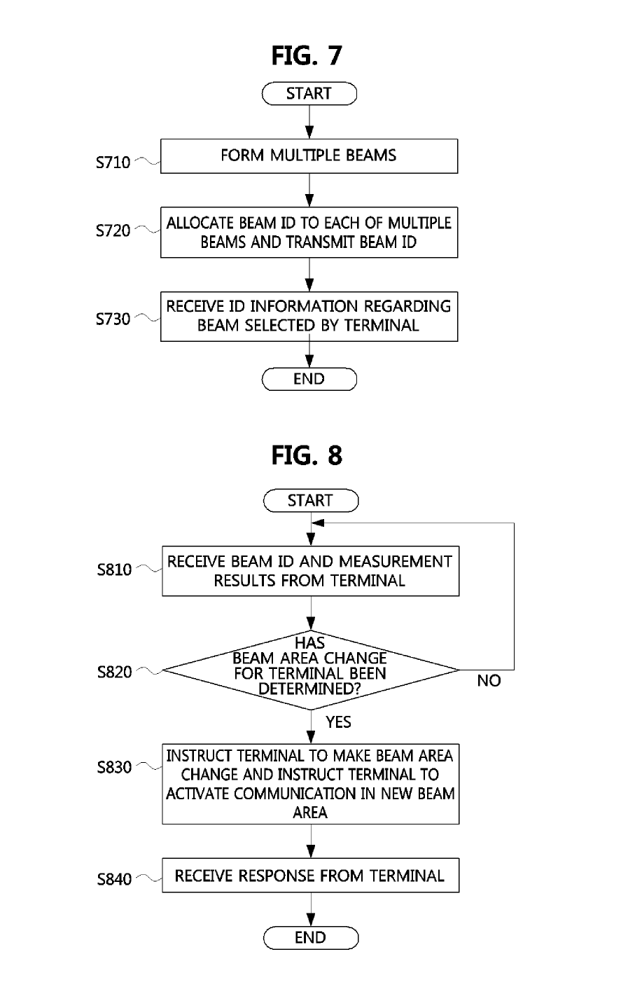

FIG. 7 is a flowchart illustrating an operation method of the base station in accordance with an example embodiment of the present invention.

Referring to FIG. 7, the operation method of the base station in accordance with the example embodiment of the present invention is the operation method of the base station for implementing the first step and the second step of the operation method of the cellular telecommunication system in accordance with the example embodiment of the present invention, which can include step S710 of forming multiple beams, step S720 of allocating a beam ID to each of the multiple beams and transmitting the beam ID corresponding to each beam using each beam, and step S730 of receiving the beam ID of the beam selected by the terminal from the terminal.

Step S710 of forming the multiple beams includes the step of performing, by the base station, beam forming, and generating the multiple beams on a space. At this time, a beam ID capable of specifying each beam is allocated to each of the multiple beams, and the beam ID corresponding to each beam is transmitted using each beam. In this case, the beam ID can be broadcast through a synchronization signal or a system information broadcast channel.

As described above, the base station can generate and operate a plurality of fine and precise beams using beam forming technologies (in particular, in the SHF/EHF band). Each beam can have radio channels for transmitting independent control information and data. Accordingly, the base station can allocate an ID to each generated beam. Beam ID information can be transmitted using a synchronization signal or a system information transmission channel corresponding to each beam.

Here, steps S710 and S720 define the operation of the base station belonging to the first step of the operation method of the cellular telecommunication system in accordance an example embodiment of the present invention described above.

Next, as the step of receiving, by the base station, the beam ID of the beam selected by the terminal from the terminal, step S730 is the step in which the base station receives a report of information regarding an optimum beam selected by the terminal from among the multiple beams generated by the base station.

At this time, the terminal can be configured to report beam ID information regarding its own selected beam in a random access scheme using the random access channel.

FIG. 8 is a flowchart illustrating an operation method of the base station in accordance with another example embodiment of the present invention.

Referring to FIG. 8, the operation method of the base station in accordance with the other example embodiment of the present invention is the operation method of the base station for implementing the third step of the operation method of the cellular telecommunication system in accordance with the example embodiment of the present invention described above, which can include step S810 of receiving an ID and radio quality measurement results of at least one beam received by a terminal from the terminal, step S820 of determining a beam area change for the terminal based on the radio quality measurement results, step S830 of instructing the terminal for which the beam area change is determined to make the beam area change using a first message, and instructing the terminal to activate communication in a new beam area using a second message; and step S840 of receiving a response including results of the beam area change and results of the communication activation in the new beam area through a third message from the terminal.

In step S810, the base station receives beam ID information received by the terminal and results obtained by measuring radio qualities of beams as a measurement report from the terminal. At this time, the measurement report can be periodically or aperiodically received from the terminal. When the measurement report is periodically received, a cycle value can be set by the base station. The measurement report can be set to be transmitted if a condition of an event is satisfied by defining various events, such as when a radio quality difference between two or more beams received by the terminal exceeds a predetermined standard, when radio equality of a beam in service for the terminal is degraded to a predetermined standard or less, when the terminal newly measures a beam having better radio quality, which is at least a predetermined standard better than the radio quality of the beam in service, and the like.

In step S820, the base station determines a beam area change for the terminal based on measurement results received from the terminal.

For example, the base station analyzes measurement results of each beam when there are two or more currently receivable beams through a measurement report message delivered from the terminal, and determines a beam area change for the terminal. For example, when there is a beam having better radio quality than radio quality of a beam in service among beams reported by the terminal, the base station can determine the beam area change to the beam having the better radio quality.

In step S830, the base station instructs the terminal for which the beam area change is determined to make the beam area change using a first message, and instructs the terminal to activate communication in the new beam area using a second message. At this time, an RRC layer message can be used as the first message. As a specific example, an RRC connection reconfiguration message can be used as the first message. At this time, a message of a CE of the MAC layer can be used as the second message.

In step S840, the base station can receive a response including results of the beam area change and results of the communication activation in the new beam area through a third message from the terminal. At this time, like the above-described first message, an RRC layer message can be used as the third message. As a specific example, an RRC connection reconfiguration complete message can be used as the third message.

Operation Method of Terminal in Accordance with Example Embodiment of Present Invention

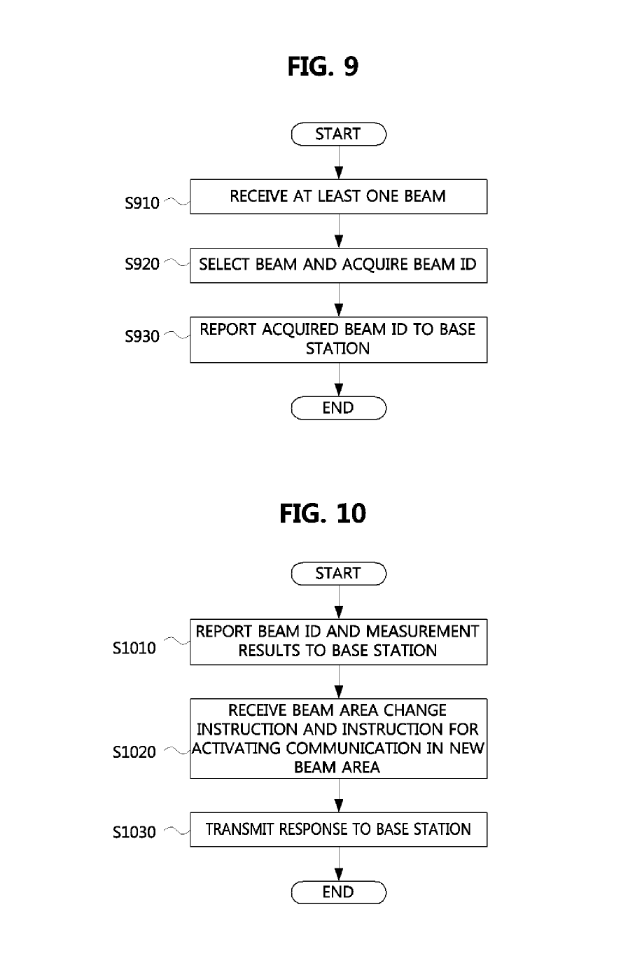

FIG. 9 is a flowchart illustrating an operation method of the terminal in accordance with an example embodiment of the present invention.

Referring to FIG. 9, the operation method of the terminal in accordance with the example embodiment of the present invention is the operation method of the base station for implementing the first step and the second step of the operation method of the cellular telecommunication system in accordance with the example embodiment of the present invention, which can include step S910 of receiving at least one beam, step S920 of selecting one of the received at least one beam and acquiring a beam ID from the selected beam, and step S930 of reporting the acquired beam ID to a base station.

In step S910, the terminal receives the multiple beams generated by the base station. At this time, the terminal can receive only one beam or multiple beams that overlap according to an area in which the terminal is currently located.

In step S920, the terminal selects a beam through which service is to be received from among at least one beam received by the terminal, and acquires a beam ID of the selected beam. Although the terminal can generally select a beam having best reception quality, a criterion for selecting its own optimum beam may differ according to an operation policy (for example, a load, a distribution, or the like) of the cellular telecommunication system. The terminal can acquire beam ID information regarding the selected beam through a synchronization signal or a system information broadcast channel. In the example of the 3GPP LTE system, the terminal can be configured to acquire the beam ID information through the synchronization signal (PSS/SSS) and the system information broadcast channel (PBCH) of the selected beam.

Finally, in step S930, the terminal reports the acquired beam ID to the base station.

As an example of a method of reporting the acquired beam ID information to the base station, the information can be configured to be transmitted as a random access message (for example, including a random access preamble) through a random access channel. Because the terminal is likely to be in a state in which uplink synchronization with the base station is not acquired, it is preferable to use a random access scheme, but other message transmission methods may be used.

FIG. 10 is a flowchart illustrating an operation method of the terminal in accordance with another example embodiment of the present invention.

Referring to FIG. 10, the operation method of the terminal in accordance with the other example embodiment of the present invention is the operation method of the base station for implementing the third step of the operation method of the cellular telecommunication system in accordance with the example embodiment of the present invention described above, which can include step S1010 of reporting an ID and radio quality measurement results of at least one beam received by the terminal to a base station, step S1020 of receiving a beam area change instruction from the base station through a first message and receiving an instruction for activating communication in a new beam area through a second message, and step S1030 of transmitting a response including beam area change results and communication activation results in the new beam area to the base station using a third message.

In step S1010, the terminal reports beam ID information received by the terminal and results obtained by measuring radio qualities of the beams as a measurement report to the base station. At this time, the measurement report can be periodically or aperiodically reported to the base station. When the measurement report is periodically transmitted, a cycle value can be set by the base station. The measurement report can be set to be transmitted if a condition of an event is satisfied by defining various events, such as when a radio quality difference between two or more beams received by the terminal exceeds a predetermined standard, when radio equality of a beam in service for the terminal is degraded to a predetermined standard or less, when the terminal newly measures a beam having better radio quality, which is at least a predetermined standard better than the radio quality of the beam in service, and the like.

In step S1020, the terminal receives the beam area change instruction from the base station through the first message, and receives the instruction for activating communication in the new beam area through the second message. At this time, an RRC layer message can be used as the first message. As a specific example, an RRC connection reconfiguration message can be used as the first message. At this time, a message of a CE of the MAC layer can be used as the second message.

In step S1030, the terminal can transmit the response including the beam area change results and the communication activation results in the new beam area (that is, processing results for the instruction of step S1020 or an acknowledgement for instruction reception) to the base station using the third message. At this time, like the above-described first message, an RRC layer message can be used as the third message. As a specific example, an RRC connection reconfiguration complete message can be used as the third message.

When the operation method of the cellular telecommunication system in accordance with the example embodiment of the present invention as described above is used, the base station can rapidly sense the entry of the terminal into a specific beam area. Even when the terminal moves between beam areas, it is possible to make a beam area change with a minimum overhead without performing random access again or performing a complex procedure such as a handover procedure.

While the example embodiments of the present invention and their advantages have been described in detail, it should be understood that various changes, substitutions and alterations may be made herein without departing from the scope of the invention.

What is claimed is:

1. A method of operating a base station in a cellular telecommunication system for operating multiple beams, comprising:
forming the multiple beams;
allocating a beam identifier (ID) to each of the multiple beams, and transmitting the beam ID corresponding to each beam using each beam; and
receiving the beam ID of the beam selected by a terminal from the terminal.

2. The method of claim 1, wherein the cellular telecommunication system uses a super high frequency (SHF) or extremely high frequency (EHF) band as an operation band.

3. The method of claim 1, wherein the beam ID is broadcast through a synchronization signal or system information broadcast channel transmitted using each beam.

4. The method of claim 1, wherein the beam ID is received from the terminal through a random access channel.

5. A method of operating a terminal in a cellular telecommunication system for operating multiple beams, comprising:
receiving at least one beam;
selecting one of the received at least one beam, and acquiring a beam ID from the selected beam; and
reporting the acquired beam ID to a base station.

6. The method of claim 5, wherein the cellular telecommunication system uses an SHF or EHF band as an operation band.

7. The method of claim 5, wherein the beam ID is acquired from a synchronization signal or system information broadcast channel received through the selected beam.

8. The method of claim 5, wherein the acquired beam ID is reported to the base station through a random access channel.

9. A method of operating a base station in a cellular telecommunication system for operating multiple beams, comprising:
receiving an ID and radio quality measurement results of at least one beam received by a terminal from the terminal;
determining a beam area change for the terminal based on the radio quality measurement results;
instructing the terminal for which the beam area change is determined to make the beam area change using a first message, and instructing the terminal to activate communication in a new beam area using a second message; and
receiving a response including results of the beam area change and results of the communication activation in the new beam area from the terminal through a third message.

10. The method of claim 9, wherein the determining includes:
determining the beam area change to a second beam when the second beam has better radio quality than a first beam in service for the terminal based on the radio quality measurement results reported from the terminal.

11. The method of claim 9, wherein the first message and the third message include radio resource control (RRC) layer messages.

12. The method of claim 11,
wherein the first message includes an RRC connection reconfiguration message, and
wherein the third message includes an RRC connection reconfiguration complete message.

13. The method of claim 9, wherein the second message includes a media access control (MAC) layer control element (CE) message.

14. A method of operating a terminal in a cellular telecommunication system for operating multiple beams, comprising:
reporting an ID and radio quality measurement results of at least one beam received by the terminal to a base station;
receiving a beam area change instruction from the base station through a first message, and receiving an instruction for activating communication in a new beam area through a second message; and
transmitting a response including beam area change results and communication activation results in the new beam area to the base station using a third message.

15. The method of claim 14, wherein the first message and the third message include RRC layer messages.

16. The method of claim 15,
wherein the first message includes an RRC connection reconfiguration message, and
wherein the third message includes an RRC connection reconfiguration complete message.

17. The method of claim 14, wherein the second message includes a MAC layer CE message.
